(19) United States
(12) Patent Application Publication
(10) Pub. No.: US 2008/0221952 A1
(43) Pub. Date: Sep. 11, 2008

(54) WORKFLOW MANAGEMENT SYSTEM, WORKFLOW MANAGEMENT SERVER, PROGRESS MANAGEMENT METHOD, AND STORAGE MEDIUM

(76) Inventor: Takanori MOHRI, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/042,736

(22) Filed: Mar. 5, 2008

(30) Foreign Application Priority Data
Mar. 7, 2007 (JP) 2007-057884

(51) Int. Cl. G06Q 10/00; G06F 7/06; G06F 17/30

(52) U.S. Cl. 705/7; 709/201; 707/2; 707/E17.017

(57) ABSTRACT

A workflow management server for managing task information of tasks constituting a workflow is disclosed. The disclosed workflow management server includes a circulation route information storing unit configured to store circulation route information defining a circulation route of a progress report on progress of the tasks; a task information retrieving unit configured to retrieve the task information of the tasks to be included in the progress report from a database according to a user request; a progress report generating unit configured to generate the progress report based on the task information retrieved by the task information retrieving unit and the circulation route information read from the circulation route information storing unit; and a progress report sending unit configured to send the progress report generated by the progress report generating unit to terminals according to the circulation route defined by the circulation route information.

### BACKGROUND OF THE INVENTION

1. Field of the Invention

The present invention generally relates to a workflow management system for managing workflows each comprising hierarchically-structured tasks.

2. Description of the Related Art

Generally, a business project, such as a product development project, is composed of many tasks (work processes) and involves people in different departments and sections. Workflow management systems are widely used to efficiently manage and carry out such complex projects.

In a workflow management system, projects are managed as workflows each comprising hierarchically-structured tasks. To efficiently carry out a project, a workflow management system preferably includes a mechanism for managing progress of tasks constituting each workflow in addition to a mechanism for managing workflows themselves.

Patent document 1 discloses a workflow management system designed “to enable the user to carry out tasks without delay and omission and thereby to improve work efficiency” and including “a review/approval requesting unit for requesting a reviewer to review and/or approve a document, which review/approval requesting unit is configured to combine multiple review/approval requests according to predetermined conditions and to send the combined review/approval requests to the reviewer at once”.

In the disclosed workflow management system, when a task is completed, the user requests the review/approval requesting unit to request a reviewer (e.g., a project manager) to review and/or approve a task completion report. Thus, in the disclosed workflow management system, progress of tasks is managed by the user.

[Patent document 1] Japanese Patent Application Publication No. 2002-279335

Meanwhile, in actual project management, it is preferable to report on the progress of each task more frequently by interim progress reports, such as a daily report, a weekly report, and/or a monthly report, in addition to a task completion report according to the status (e.g., “completed”, “underway”, or “not started”) of the task.

However, with a conventional workflow management system as disclosed in patent document 1, the user has to check the statuses of multiple tasks of his/her responsibility, to create progress reports on the tasks, and to request a project manager to review the progress reports. Apparently, it is troublesome for the user to perform this process on a daily basis.

### SUMMARY OF THE INVENTION

Embodiments of the present invention provide a workflow management system, a workflow management server, a progress management method, and a storage medium containing program code for causing a computer to perform the program management method that solve or reduce one or more problems caused by the limitations and disadvantages of the related art.

An embodiment of the present invention provides a workflow management server for managing task information, which is stored in a database, of tasks constituting a workflow, which workflow management server is connected via a network to one or more terminals for reviewing a progress report on progress of the tasks. The workflow management server includes a circulation route information storing unit configured to store circulation route information defining a circulation route of the progress report; a task information retrieving unit configured to retrieve the task information of the tasks to be included in the progress report from the database according to a user request; a progress report generating unit configured to generate the progress report based on the task information retrieved by the task information retrieving unit and the circulation route information read from the circulation route information storing unit; and a progress report sending unit configured to send the progress report generated by the progress report generating unit to the terminals according to the circulation route defined by the circulation route information.

Another embodiment of the present invention provides a method of managing progress of tasks constituting a workflow in a workflow management system that includes a workflow management server for managing task information, which is stored in a database, of the tasks and that includes one or more terminals connected via a network to the workflow management server and used to review a progress report on the progress of the tasks. The method includes the steps of storing circulation route information defining a circulation route of the progress report in a circulation route information storing unit of the workflow management server; retrieving the task information of the tasks to be included in the progress report from the database according to a user request; generating the progress report based on the retrieved task information and the circulation route information read from the circulation route information storing unit; and sending the generated progress report to the terminals according to the circulation route defined by the circulation route information.

Still another embodiment of the present invention provides a storage medium having program code stored therein for causing a computer to function as a task information retrieving unit, a progress report generating unit, and a progress report sending unit of a workflow management server for managing task information, which is stored in a database, of tasks constituting a workflow, the workflow management server being connected via a network to one or more terminals for reviewing a progress report on progress of the tasks. The computer includes a circulation route information storing unit configured to store circulation route information defining a circulation route of the progress report; the task information retrieving unit is configured to retrieve the task information of the tasks to be included in the progress report from the database according to a user request; the progress report generating unit is configured to generate the progress report based on the task information retrieved by the task information retrieving unit and the circulation route information read from the circulation route information storing unit; and the progress report sending unit is configured to send the progress report generated by the progress report generating unit to the terminals according to the circulation route defined by the circulation route information.

### BRIEF DESCRIPTION OF THE DRAWINGS

FIG. 1 is a drawing illustrating a configuration of an exemplary workflow management system;

FIG. 2 is a drawing illustrating a hardware configuration of a workflow management server and a user terminal in the exemplary workflow management system;

FIG. 3 is a block diagram illustrating a functional configuration of the workflow management server in the exemplary workflow management system;

FIG. 4 is a table showing an exemplary structure of task information in a task information database;

FIG. 5 is a table showing an exemplary structure of user information in a user information database;

FIG. 6 is a block diagram illustrating functional units of the workflow management server and the user terminal in the exemplary workflow management system;

FIG. 7 is a drawing illustrating an exemplary progress report setting screen;

FIG. 8 is a drawing illustrating an exemplary task list screen listing tasks to be included in a progress report (all tasks constituting workflows involving a user are listed);

FIG. 9 is a drawing illustrating a task selection screen for selecting tasks to be included in a progress report;

FIG. 10 is a drawing illustrating another exemplary task list screen listing tasks to be included in a progress report (only tasks of a user are listed);

FIG. 11 is a drawing illustrating still another exemplary task list screen listing tasks to be included in a progress report (only uncompleted tasks of a user are listed);

FIG. 12 is a drawing illustrating an exemplary circulation route selection screen;

FIG. 13 is a table showing an exemplary structure of circulation route information in a circulation route information database;

FIG. 14 is a drawing illustrating an exemplary document format setting screen for specifying document formats for circulation routes;

FIG. 15 is a table showing an exemplary structure of document format information in a document format database;

FIG. 16 is a drawing showing exemplary document formats and their definition data;

FIG. 17 is a drawing illustrating an exemplary progress report screen (circulation route 1);

FIG. 18 is a drawing illustrating another exemplary progress report screen (circulation route 2 or 3); and

FIG. 19 is a sequence chart showing a task progress management process in the exemplary workflow management system.

### DESCRIPTION OF THE PREFERRED EMBODIMENTS

Preferred embodiments of the present invention are described below with reference to the accompanying drawings.

### <Configuration of Workflow Management System>

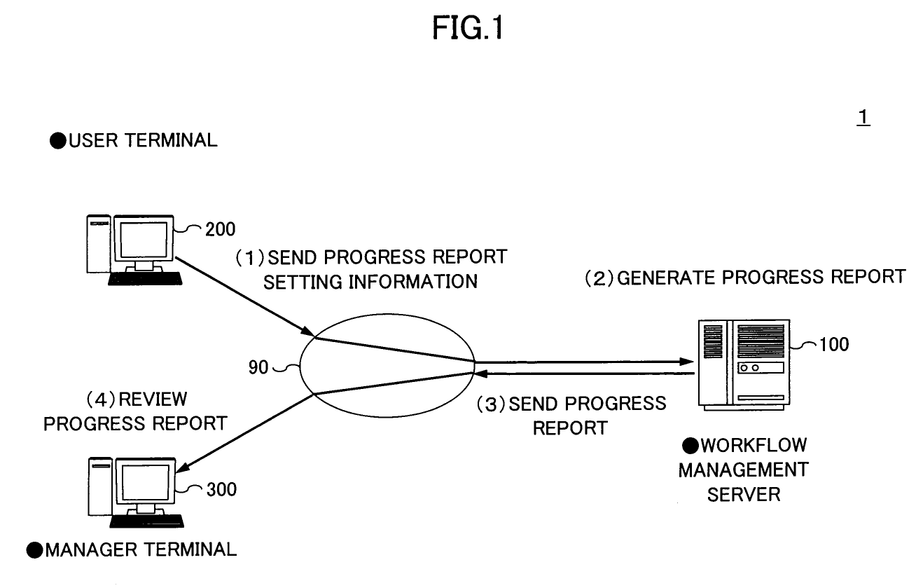

An exemplary configuration of a workflow management system 1 according to an embodiment of the present invention is described below with reference to FIG. 1.

FIG. 1 is a drawing illustrating an exemplary configuration of a workflow management system according to a first embodiment of the present invention;

The workflow management system 1 includes user terminals 200 (may be collectively referred to as the user terminal 200 for descriptive purposes) each used by a user to specify task information regarding tasks of his/her responsibility and progress report setting information including settings for a progress report; a workflow management server 100 for managing task information of hierarchically-structured tasks constituting workflows as a database; and manager terminals 300 (may be collectively referred to as the manager terminal 300 for descriptive purposes) each used by a manager (or a user) to review progress reports on the tasks managed by the workflow management server 100. The user terminals 200, the workflow management server 100, and the manager terminals 300 are connected to each other via a network (data communication network) 90 such as a wired/wireless local area network (LAN) or a wide area network (WAN).

In the workflow management system 1, progress of tasks is managed through a process as described below.

(Step 1) Sending Progress Report Setting Information

The user terminal 200 sends progress report setting information specified by the user to the workflow management server 100. The progress report setting information includes a circulation route ID identifying circulation route information (or may include circulation route information itself) defining a circulation route (sequence of managers or the manager terminals 300) according to which a progress report is to be circulated and report timing information specifying an interval at which successive progress reports are to be sent to managers (or users).

(Step 2) Generating Progress Report

Based on the progress report setting information sent from the user terminal 200, the workflow management server 100 retrieves task information of tasks to be included in a progress report from a database. Then, the workflow management server 100 generates a progress report (an electronic document) based on the retrieved task information and the circulation route information corresponding to the circulation route ID.

(Step 3) Sending Progress Report

The workflow management server 100 sends the generated progress report to the manager terminals 300 according to the circulation route defined by the circulation route information.

(Step 4) Reviewing Progress Report

Each of the manager terminals 300 included in the circulation route receives the progress report sent from the workflow management server 100 and the manager (the user of the manager terminal 300) reviews the progress report.

Thus, the workflow management system 1 includes a mechanism for performing a task progress management process of automatically generating progress reports on tasks as electronic documents and sending the generated progress reports to specified manager terminals 300, in addition to a mechanism for performing a workflow management process of managing workflows each comprising multiple tasks.

### <Hardware Configuration of Workflow Management Server and User Terminal>

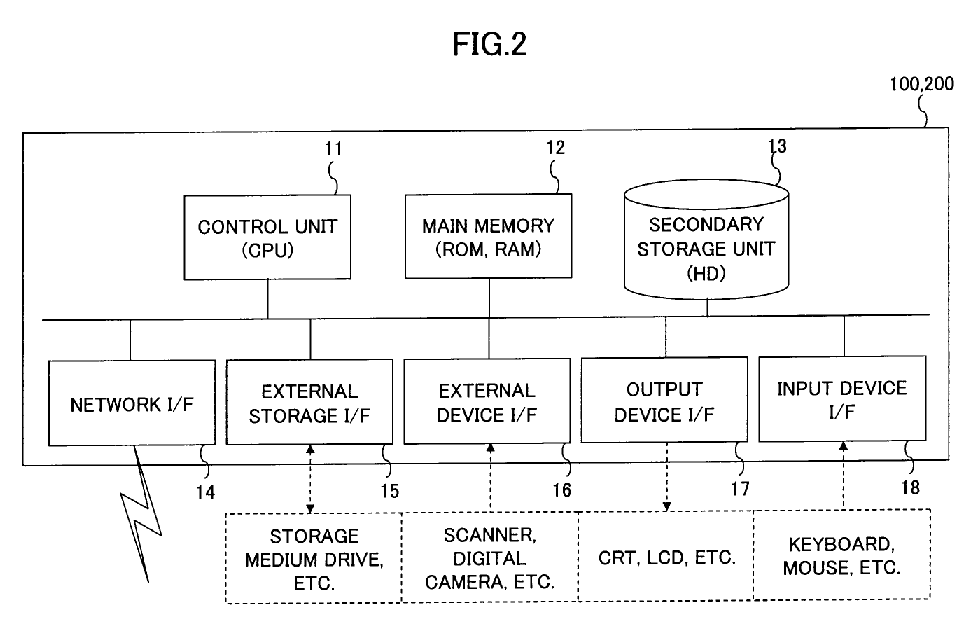

An exemplary hardware configuration of the workflow management server 100 and the user terminal 200 in the workflow management system 1 is described below with reference to FIG. 2.

FIG. 2 is a drawing illustrating an exemplary hardware configuration of the workflow management server 100 and the user terminal 200 in the workflow management system 1.

The workflow management server 100 and the user terminal 200 of this embodiment are implemented by information processing apparatuses having substantially the same hardware configuration. Therefore, only descriptions of the exemplary hardware configuration of the workflow management server 100 are given below.

As shown in FIG. 2, the workflow management server 100 includes a control unit 11 implemented by, for example, a central processing unit (CPU); a main memory 12 implemented by, for example, a read only memory (ROM) and a random access memory (RAM); a secondary storage unit 13 implemented, for example, by a hard disk (HD); a network I/F 14; an external storage I/F 15; an external device I/F 16; an output device I/F 17; and an input device I/F 18.

The control unit 11 controls other units of the workflow management server 100. Also, the control unit 11 executes programs stored in the main memory 12, thereby processes data received from an input device or a storage device, and outputs the processed data to an output device or a storage device (e.g., the control unit 11 displays characters entered via a keyboard on a display unit).

The main memory 12 permanently or temporarily stores programs to be executed and data to be processed by the control unit 11. For example, the ROM of the main memory 12 stores programs to be executed by the control unit 11 and accompanying data. The control unit 11 loads the programs and data as needed into the RAM of the main memory 12, and executes and processes the loaded programs and data.

The secondary storage unit 13 stores an operating system (OS) used as basic software and application programs together with accompanying data. The secondary storage unit 13 also stores various types of information (e.g., task information and progress report setting information) managed as databases or files by the workflow management server 100.

The network I/F 14 interfaces the workflow management server 100 and other devices (e.g., the user terminal 200 and the manager terminal 300) having communication facilities and connected to the network 90.

The external storage I/F 15 interfaces the workflow management server 100 and an external storage device (e.g., a storage medium drive) connected via a data transmission line such as a universal serial bus (USB).

The external device I/F 16 interfaces the workflow management server 100 and an external input device (e.g., an external hard disk, a USB memory, a digital camera, or a scanner) connected via a data transmission line such as a USB.

The workflow management server 100 sends/receives or writes/reads data to/from external devices via the above interfaces.

The output device I/F 17 interfaces the workflow management server 100 and an output device (e.g., a cathode ray tube (CRT) display or a liquid crystal display (LCD)) connected via a data transmission line such as a cable.

The input device I/F 18 interfaces the workflow management server 100 and an input device (e.g., a keyboard or a mouse) connected via a data transmission line such as a USB.

The workflow management server 100 implements functional units involved in a task progress management process described later by executing programs stored in the main memory 12 and the secondary storage unit 13 and thereby controlling its constituent hardware units.

### <Functional Configuration of Workflow Management Server>

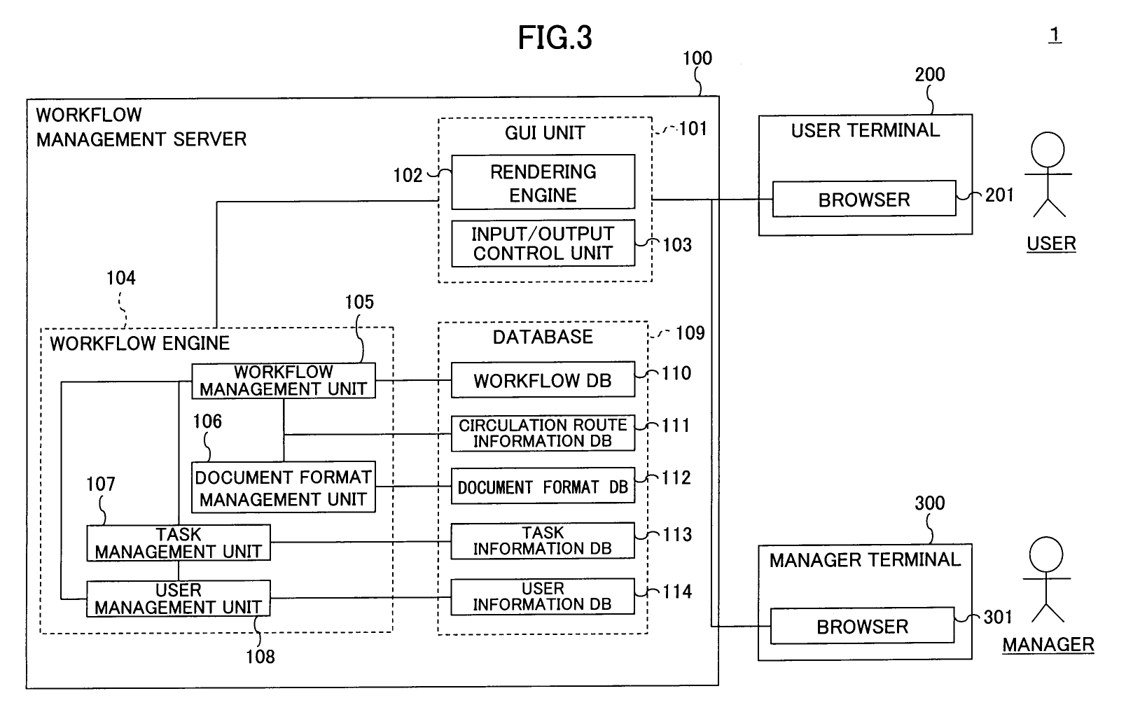

An exemplary functional configuration of the workflow management server 100, and a workflow management process and a task progress management process in the workflow management system 1 are described below with reference to FIG. 3.

FIG. 3 is a block diagram illustrating an exemplary functional configuration of the workflow management server 100.

As shown in FIG. 3, the workflow management server 100 includes a graphical user interface (GUI) unit 101 for providing graphical user interfaces for the users (including managers) of the workflow management system 1, a workflow engine 104 for managing workflows each comprising hierarchically-structured tasks, and databases (DBs) 109.

The DBs 109 include a workflow DB 110 containing workflow information defining execution sequences of tasks constituting workflows according to dependency between the tasks; a circulation route information DB 111 containing circulation route information defining circulation routes of progress reports; a document format DB 112 containing document format information correlating document formats and circulation routes, based on which document formats progress reports are generated from task information as electronic documents; a task information DB 113 containing task information regarding tasks constituting workflows; and a user information DB 114 containing user information including user IDs identifying users (including managers) and their email addresses.

The GUI unit 101 includes a rendering engine 102 for rendering screens to be displayed on the user terminal 200 and the manager terminal 300, and an input/output control unit 103 for sending and receiving information to and from the user terminal 200 and the manager terminal 300 via the network 90.

The workflow engine 104 includes a workflow management unit 105 for managing workflow information (for executing workflows, and updating, adding, and deleting workflow information) contained in the workflow DB 110; a document format management unit 106 for managing document format information (for retrieving, updating, adding, and deleting document format information) contained in the document format DB 112; a task management unit 107 for managing task information (for retrieving, updating, adding, and deleting task information) contained in the task information DB 113; and a user management unit 108 for managing user information (for retrieving, updating, adding, and deleting user information) contained in the user information DB 114.

An exemplary workflow management process in the workflow management system 1 is described below. First, the user enters a workflow execution request on a graphical user interface generated by the GUI unit 101 and displayed on the user terminal 200.

When the workflow execution request is received by the workflow management server 100, the workflow management unit 105 of the workflow engine 104 retrieves workflow information of a workflow specified in the workflow execution request from the workflow DB 110 and starts the workflow. Alternatively, the workflow management server 100 may be configured to automatically start a workflow at a start time specified by the user. Then, the task management unit 107 of the workflow engine 104 retrieves task information of tasks constituting the workflow from the task information DB 113 and executes the tasks according to an execution sequence defined in the workflow information.

Along with the execution of the tasks, the GUI unit 101 displays messages prompting the users to perform the corresponding user tasks on the user terminals 200.

An exemplary task progress management process in the workflow management system 1 is described below. First, on a graphical user interface generated by the GUI unit 101 and displayed on the user terminal 200, the user specifies progress report setting information including a circulation route ID identifying circulation route information (or circulation route information itself) defining a circulation route according to which a progress report is to be circulated and report timing information specifying an interval at which successive progress reports are to be sent to managers (or users). The specified progress report setting information is sent from the user terminal 200 to the workflow management server 100 and received by the input/output control unit 103 of the GUI unit 101.

In the workflow management server 100, the task management unit 107 of the workflow engine 104 determines a report timing to send a progress report based on a timer and the report timing information in the progress report setting information. At the report timing, the task management unit 107 retrieves task information of tasks to be included in a progress report from the task information DB 113. Then, the document format management unit 106 of the workflow engine 104 searches the document format DB 112 and thereby identifies and retrieves definition data defining a document format corresponding to a circulation route ID in the progress report setting information.

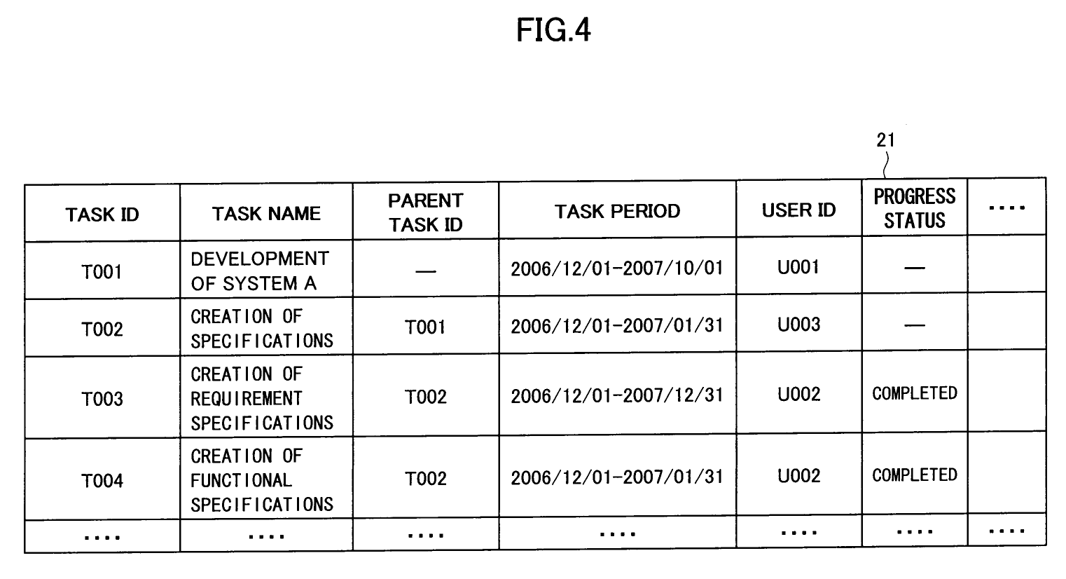

FIG. 4 is a table showing an exemplary structure of task information 21 in the task information database 113.

As shown in FIG. 4, the task information DB 113 contains the task information 21 for each task.

The task information 21 includes a task ID identifying a task, a task name, a parent task ID identifying a parent task (indicating a hierarchical structure of tasks), a task period indicating start and completion dates of the task, a user ID identifying a user in charge, and a progress status indicating the status of the task.

The task management unit 107 is able to search the task information DB 113 for the task information 21 using the above fields as search keys.

Referring back to FIG. 3, the user management unit 108 of the workflow engine 104 retrieves user information of users from the user information DB 114 based on the user IDs in the task information 21 retrieved by the task management unit 107, and retrieves user information of managers based on manager names in circulation route information corresponding to the circulation route ID in the progress report setting information.

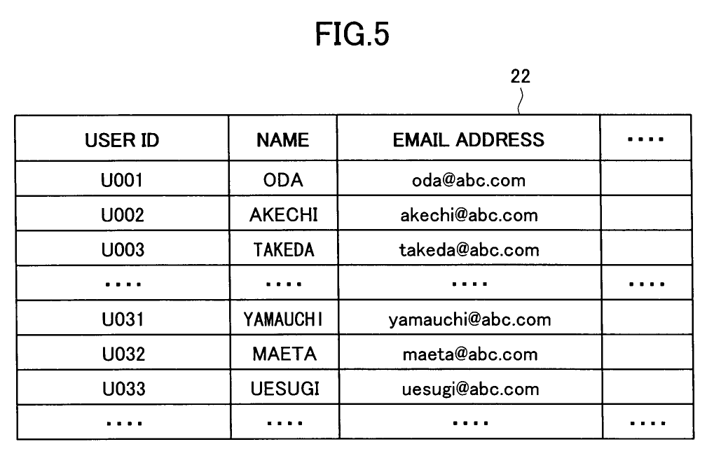

FIG. 5 is a table showing an exemplary structure of user information 22 in the user information DB 114.

As shown in FIG. 5, the user information DB 114 contains the user information 22 for each user.

The user information 22 includes a user ID identifying a user or a manager, a user name, and an email address.

The user management unit 108 is able to search the user information DB 114 for the user information 22 of users and managers using the above fields as search keys.

Referring back to FIG. 3, the workflow management unit 105 of the workflow engine 104 generates a progress report as an electronic document based on the definition data retrieved by the document format management unit 106 and the task information 21 retrieved by the task management unit 107, and sends the generated progress report to the manager terminals 300.

Meanwhile, the user terminal 200 includes a browser 201 for displaying a graphical user interface rendered by the rendering engine 102 of the GUI unit 101 of the workflow management server 100.

With the browser 201, the user is able to view the task information 21 of tasks of his/her responsibility, to update progress statuses (e.g., “completed”, “underway”, and “not started”) of the tasks, and to specify progress report setting information including a circulation route ID and report timing information.

Similarly, the manager terminal 300 includes a browser 301 for displaying a graphical user interface rendered by the rendering engine 102 of the GUI unit 101 of the workflow management server 100.

With the browser 301, the manager (the user of the manager terminal 300) is able to review progress reports (electronic documents generated based on specified document formats) on tasks of users, to set document formats for different types of progress reports (e.g. daily report, weekly report, and monthly report), and to set circulation routes for the different types of progress reports.

As described above, the workflow management server 100 provides a mechanism for automatically generating progress reports on tasks as electronic documents and sending the generated progress reports to specified manager terminals 300 by executing programs loaded into the main memory 12 with the control unit 11.

### <Functional Units Involved in Task Progress Management Process>

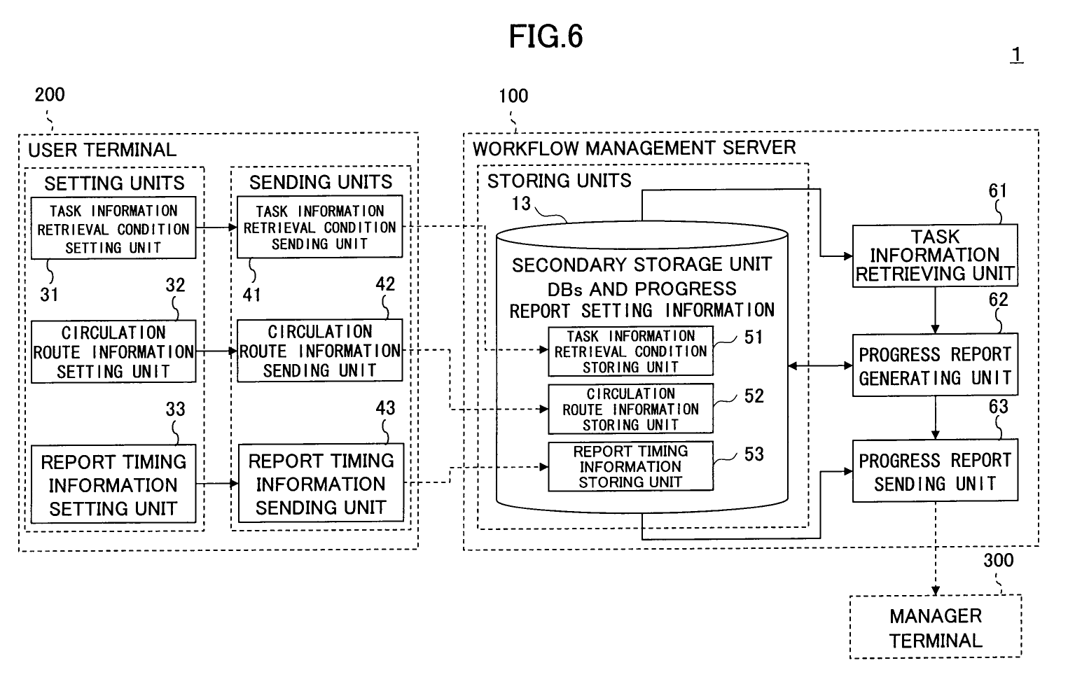

Functional units of the workflow management server 100 and the user terminal 200 involved in a task progress management process are described below with reference to FIGS. 6 through 18.

FIG. 6 is a block diagram illustrating functional units of the workflow management server 100 and the user terminal 200 in the workflow management system 1.

As shown in FIG. 6, the user terminal 200 includes functional units for specifying progress report setting information, and the workflow management server 100 includes functional units for generating progress reports on tasks as electronic documents and sending the generated progress reports to specified manager terminals 300.

[Functional Units of User Terminal]

The user terminal 200 includes a task information retrieval condition setting unit 31, a circulation route information setting unit 32, a report timing information setting unit 33, a task information retrieval condition sending unit 41, a circulation route information sending unit 42, and a report timing information sending unit 43.

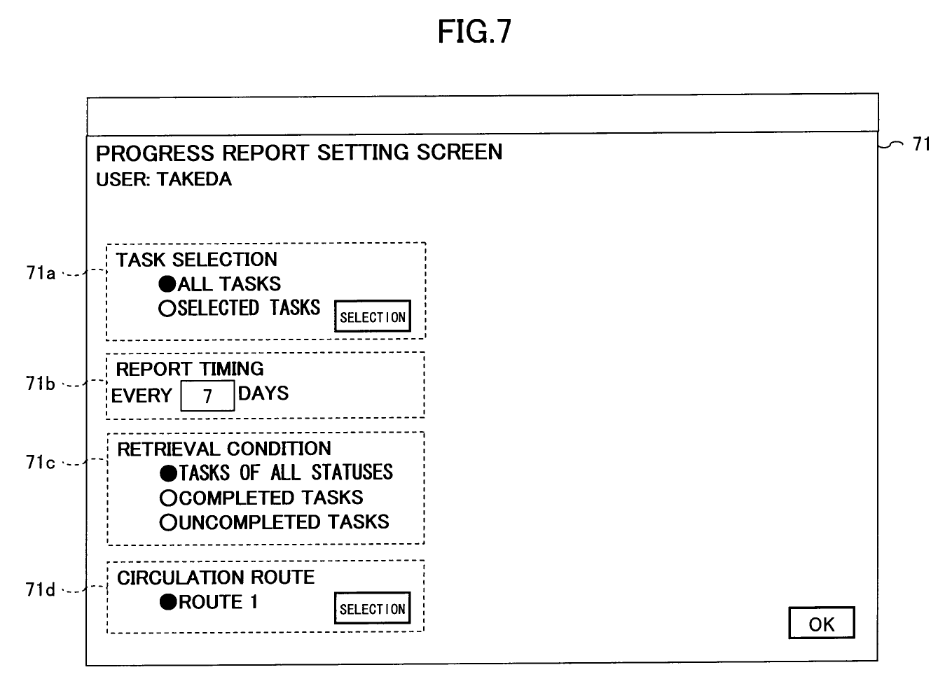

FIG. 7 is a drawing illustrating an exemplary progress report setting screen.

The user specifies progress report setting information on the progress report setting screen displayed as a GUI 71 on an output unit, such as a CRT or an LCD, connected via the output device I/F 17 to the user terminal 200. The GUI 71 is rendered by the rendering engine 102 of the GUI unit 101 of the workflow management server 100.

The task information retrieval condition setting unit 31 sets retrieval conditions (task information retrieval conditions), which constitute a part of progress report setting information, for retrieving the task information 21 of tasks to be included in a progress report.

More specifically, the task information retrieval condition setting unit 31 receives and sets retrieval conditions corresponding to an option (radio button) selected by the user in a retrieval condition setting area 71c surrounded by a dotted line on the GUI 71.

In FIG. 7, three options are provided in the retrieval condition setting area 71c: “Tasks of All Statuses” indicating tasks that are completed, underway, or not started yet; “Completed Tasks” indicating tasks that are completed; and “Uncompleted Tasks” that are underway or not started yet. In the example shown in FIG. 7, “Tasks of All Statuses” is selected. The task information retrieval condition setting unit 31 receives retrieval conditions corresponding to an identification code assigned to the selected option. The retrieval conditions are used as search keys by the workflow management server 100 to retrieve the corresponding task information 21 from the task information DB 113. For example, search conditions include a user name such as “Takeda” and a progress status of tasks such as “Completed” or “Uncompleted”.

A task selection area 71a surrounded by a dotted line on the GUI 71 shown in FIG. 7 includes options (radio buttons) for setting a task selection method of selecting tasks to be included in a progress report.

In FIG. 7, two options are provided in the task selection area 71a: “All Tasks” and “Selected Tasks”.

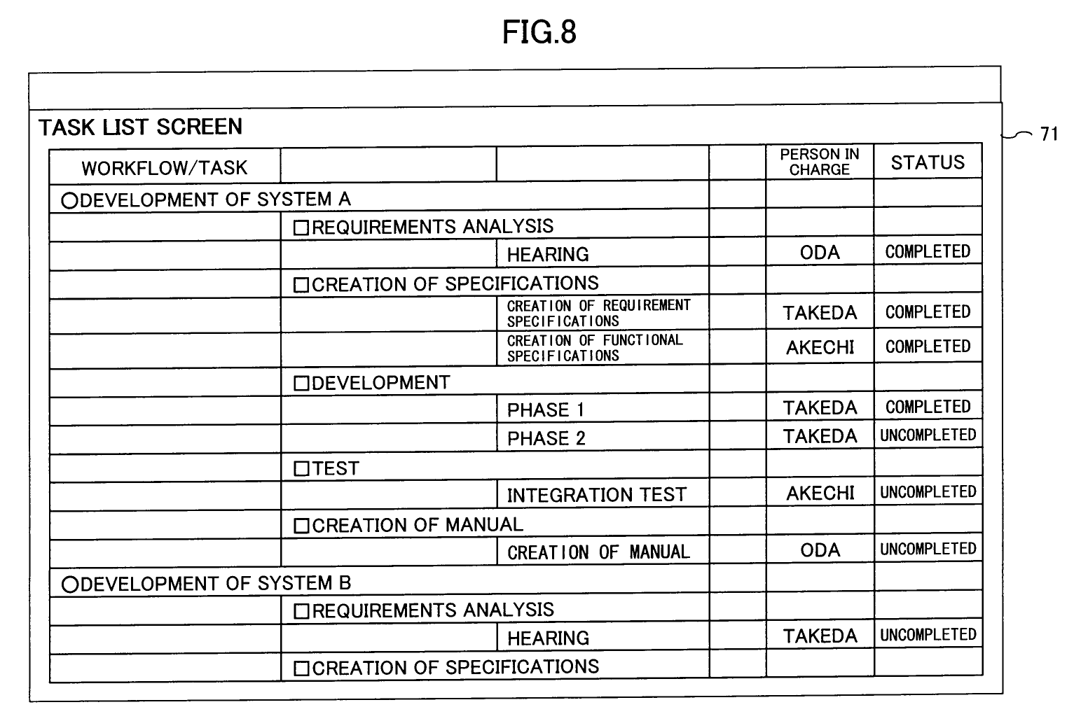

FIG. 8 is a drawing illustrating an exemplary task list screen listing tasks to be included in a progress report (all tasks constituting workflows involving a user are listed).

For example, if “All Tasks” is selected as shown in FIG. 7, a task list screen listing all tasks constituting workflows involving the user is displayed as shown in FIG. 8.

In FIG. 8, tasks constituting workflows involving a user “Takeda” are displayed.

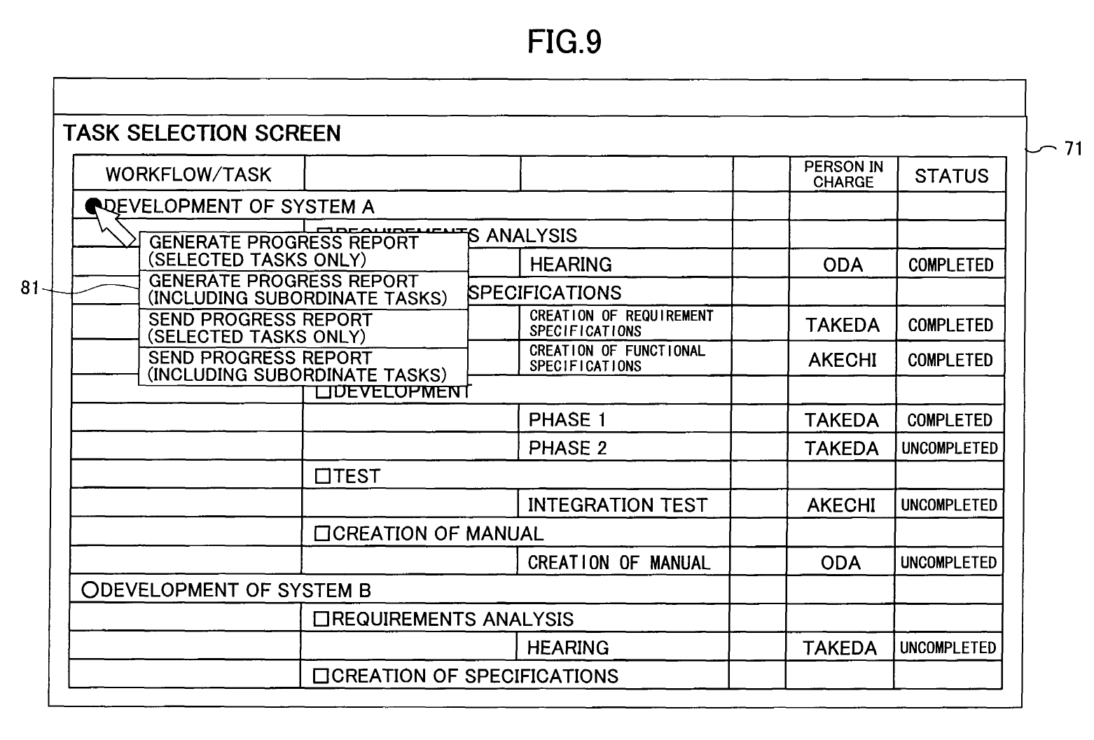

FIG. 9 is a drawing illustrating a task selection screen for selecting tasks to be included in a progress report.

If “Selected Tasks” is selected, a “Selection” button in the task selection area 71a becomes available. When the user clicks on the “Selection” button, a task selection screen for selecting tasks to be included in a progress report is displayed as the GUI 71 as shown in FIG. 9.

In FIG. 9, a “Development of system A” workflow is selected by the user.

When the user right-clicks on a workflow, a menu 81 is displayed as shown in FIG. 9 and allows the user to select an appropriate action. The menu 81 includes the following commands: “Generate progress report (selected tasks only)”, “Generate progress report (including subordinate tasks)”, “Send progress report (selected tasks only)”, and “Send progress report (including subordinate tasks)”.

Referring back to FIG. 7, when, for example, “All Tasks” is selected (i.e., all tasks constituting workflows involving the user are selected to be included in a progress report as shown in FIG. 8), the task information retrieval condition setting unit 31 narrows down the selected tasks using the retrieval conditions set as described above.

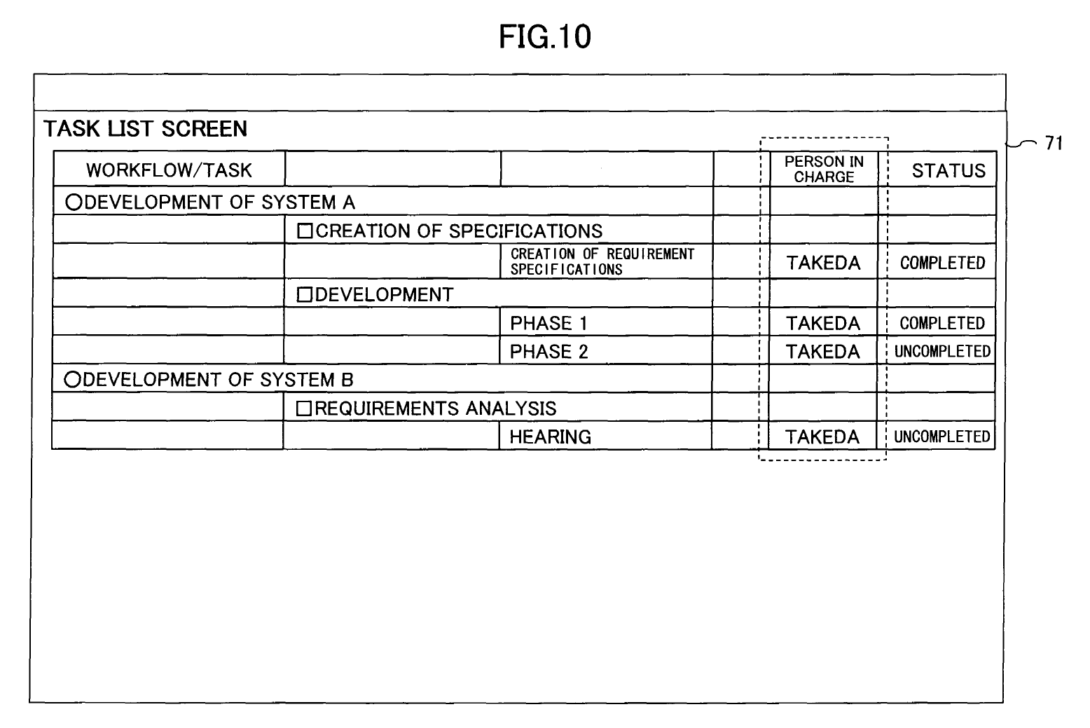

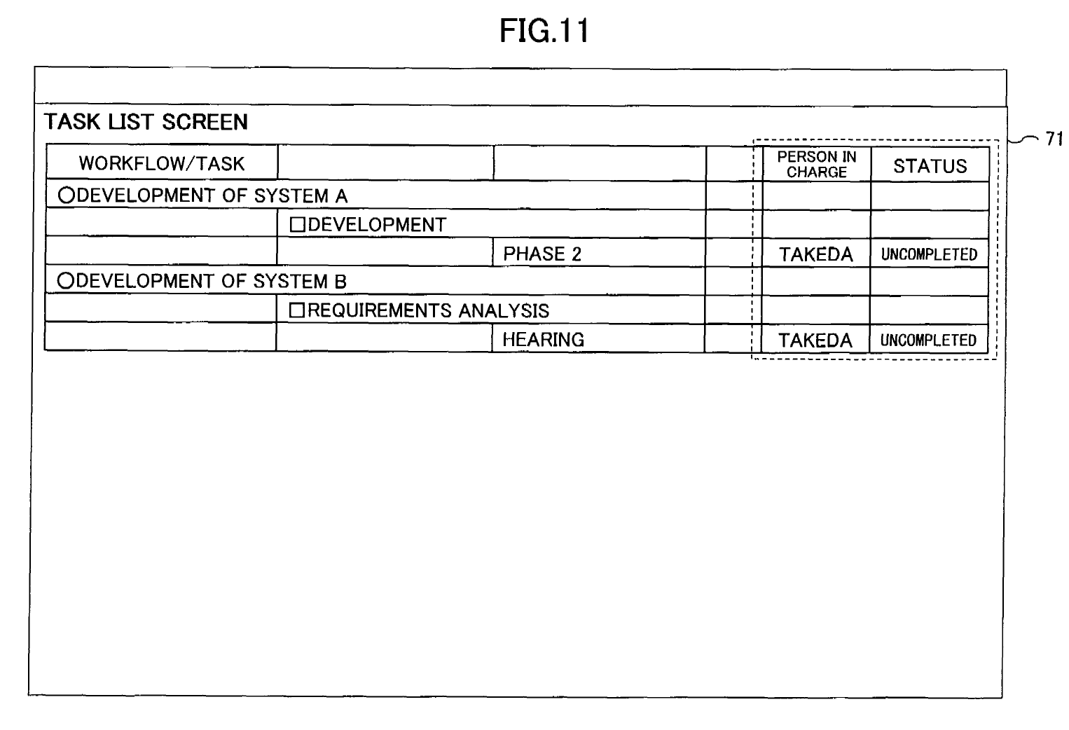

FIG. 10 is a drawing illustrating another exemplary task list screen listing tasks to be included in a progress report (only tasks of a user are listed). FIG. 11 is a drawing illustrating still another exemplary task list screen listing tasks to be included in a progress report (only uncompleted tasks of a user are listed).

In FIG. 10, tasks of a user “Takeda” are selected, as indicated in an area surrounded by a dotted line, from all tasks constituting workflows involving the user “Takeda”.

In FIG. 11, “Uncompleted” tasks (which are underway or not started yet) of a user “Takeda” are selected, as indicated in an area surrounded by a dotted line, from all tasks constituting workflows involving the user “Takeda”.

Thus, the task information retrieval condition setting unit 31 of the user terminal 200 enables the user to flexibly select tasks to be included in a progress report.

The circulation route information setting unit 32 shown in FIG. 6 sets a circulation route ID, which constitutes a part of progress report setting information, identifying circulation route information defining a circulation route according to which a progress report is to be circulated. Alternatively, the circulation route information setting unit 32 may be configured to set circulation route information itself.

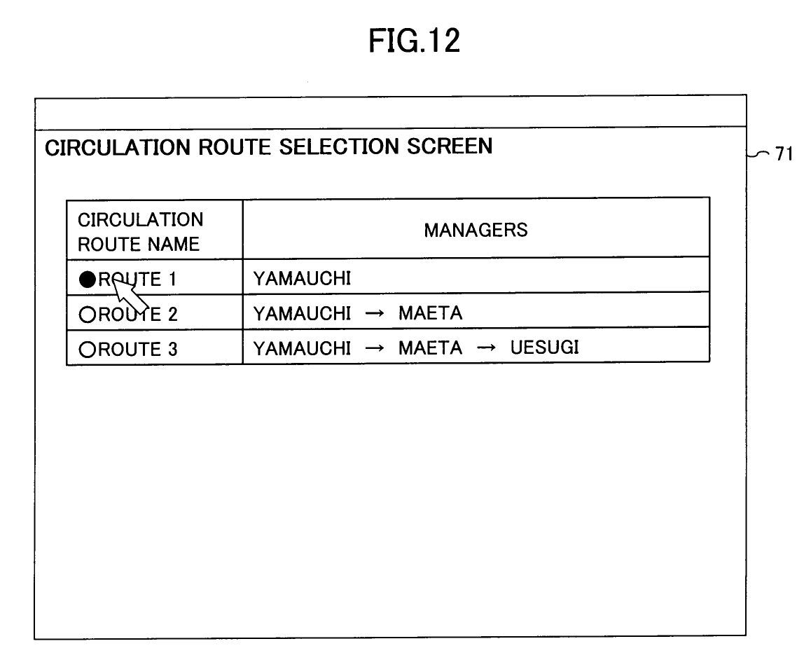

FIG. 12 is a drawing illustrating an exemplary circulation route selection screen.

When the user clicks on a “Selection button” in a circulation route setting area 71d surrounded by a dotted line on the GUI 71 shown in FIG. 7, a circulation route selection screen for selecting a circulation route is displayed as the GUI 71 as shown in FIG. 12.

The circulation route information setting unit 32 receives and sets a circulation route ID (or circulation route information itself) corresponding to an option (radio button) selected by the user on the circulation route selection screen.

On the circulation route selection screen shown in FIG. 12, three circulation routes, “Route 1”, “Route 2”, and “Route 3”, are provided, and one or more managers (or users) are specified for each of the circulation routes. In this example, “Route 1” is selected by the user. The circulation route information setting unit 32 receives a circulation route ID assigned to the selected option and identifying circulation route information. Alternatively, the circulation route information setting unit 32 may be configured to receive circulation route information itself that defines a circulation route according to which a progress report is to be sent.

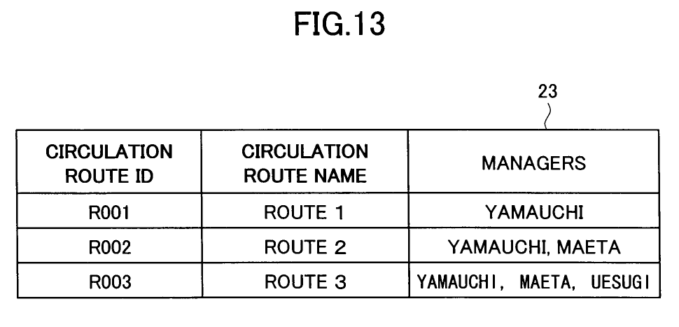

FIG. 13 is a table showing an exemplary structure of circulation route information 23 in the circulation route information DB 111.

As shown in FIG. 13, the circulation route information DB 111 contains the circulation route information 23 for each circulation route.

The circulation route information 23 includes a circulation route ID identifying the circulation route information 23, a circulation route name of a circulation route defined by the circulation route information 23, and a list of managers who review a progress report in the circulation route.

The circulation route ID received by the circulation route information setting unit 32 corresponds to one of the circulation route IDs in the circulation route information 23 stored in the circulation route information DB 111.

Thus, the circulation route information setting unit 32 of the user terminal 200 enables the user to easily select a circulation route of a progress report.

The report timing information setting unit 33 shown in FIG. 6 sets report timing information, which constitutes a part of progress report setting information, specifying an interval at which successive progress reports are to be sent to managers. At the specified interval, the workflow management server 100 retrieves the task information 21 of tasks to be included in a progress report from the task information DB 113, generates the progress report from the task information 21, and sends the generated progress report to the corresponding manager terminals 300.

The report timing information setting unit 33 receives and sets the report timing information that is the number of days entered by the user in a text box in a report timing setting area 71b surrounded by a dotted line on the GUI 71 shown in FIG. 7.

The report timing information can be set according to the type of progress report such as a daily report, a weekly report, or a monthly report. In FIG. 7, “7” days is specified by the user as the report timing information (or the interval) for a weekly report. The report timing information setting unit 33 receives the number of days or an integer entered in the text box as text.

Thus, the report timing information setting unit 33 of the user terminal 200 enables the user to flexibly specify the interval at which a recurring progress report is to be sent to the corresponding manager terminals 300.

Referring back to FIG. 6, the task information retrieval condition sending unit 41, the circulation route information sending unit 42, and the report timing information sending unit 43 of the user terminal 200, respectively, send the information set by the task information retrieval condition setting unit 31, the circulation route information setting unit 32, and the report timing information setting unit 33 to the workflow management server 100.

The task information retrieval condition sending unit 41 sends the retrieval conditions (e.g. character strings) set by the task information retrieval condition setting unit 31 to the workflow management server 100 via the network I/F 14 and the network 90.

The circulation route information sending unit 42 sends the circulation route ID (or the circulation route information itself) set by the circulation route information setting unit 32 to the workflow management server 100 via the network I/F 14 and the network 90.

The report timing information sending unit 43 sends the report timing information (e.g., an integer representing the number of days) set by the report timing information setting unit 33 to the workflow management server 100 via the network I/F 14 and the network 90.

The sending units 41, 42, and 43 send the respective parts of progress report setting information specified by the user to the workflow management server 100 when the user clicks on an “OK” button on the GUI 71 shown in FIG. 7. Alternatively, the sending units 41, 42, and 43 of the user terminal 200 may be integrated as a progress report setting information sending unit that sends all parts of progress report setting information at once.

[Functional Units of Workflow Management Server]

As shown in FIG. 6, the workflow management server 100 includes a task information retrieval condition storing unit 51, a circulation route information storing unit 52, a report timing information storing unit 53, a task information retrieving unit 61, a progress report generating unit 62, and a progress report sending unit 63.

The task information retrieval condition storing unit 51, the circulation route information storing unit 52, and the report timing information storing unit 53 store the respective parts of progress report setting information sent from the sending units 41, 42, and 43 of the user terminal 200 in a non-volatile storage device, e.g., the secondary storage unit 13, of the workflow management server 100.

In the secondary storage unit 13 or any other non-volatile storage device of the workflow management server 100, a storage area is allocated for each part of progress report setting information, i.e., task information retrieval conditions, circulation route IDs, and report timing information. The task information retrieval condition storing unit 51, the circulation route information storing unit 52, and the report timing information storing unit 53 store the respective parts of progress report setting information in their respective storage areas (e.g., in a table format). In the present application, each of the storing units 51, 52, and 53 may also indicate the allocated storage area itself.

The task information retrieval condition storing unit 51 stores the retrieval conditions sent from the task information retrieval condition sending unit 51 in a non-volatile storage device, e.g., the secondary storage unit 13, of the workflow management server 100.

For example, the task information retrieval condition storing unit 51 stores retrieval conditions, which are received from the user terminal 200 and temporarily stored in the RAM of the main memory 12, in a task information retrieval condition area of the secondary storage unit 13.

The circulation route information storing unit 52 stores the circulation route ID (or the circulation route information itself) sent from the circulation route information sending unit 42 in a non-volatile storage device, e.g., the secondary storage unit 13, of the workflow management server 100.

For example, the circulation route information storing unit 52 stores the circulation route ID (or the circulation route information itself), which is received from the user terminal 200 and temporarily stored in the RAM of the main memory 12, in a circulation route information area of the secondary storage unit 13.

The report timing information storing unit 53 stores report timing information (e.g., an integer representing the number of days) sent from the report timing information sending unit 43 in a non-volatile storage device, e.g., the secondary storage unit 13, of the workflow management server 100.

For example, the report timing information storing unit 53 stores report timing information, which is received from the user terminal 200 and temporarily stored in the RAM of the main memory 12, in a report timing information area of the secondary storage unit 13.

Alternatively, the storing units 51, 52, and 53 of the workflow management server 100 may be integrated as a progress report setting information storing unit that stores all parts of progress report setting information.

The workflow management server 100 of this embodiment generates and sends a progress report based on progress report setting information stored in a non-volatile storage device such as the secondary storage 13.

The task information retrieving unit 61 retrieves the task information 21 of tasks to be included in a progress report from the task information DB 113.

For example, the task information retrieving unit 61 retrieves the task information 21 of tasks selected by the user as shown in FIG. 8 or 9 from the task information DB 113.

If “Generate progress report (including subordinate tasks)” is selected in the menu 81 shown in FIG. 9 and if the selected tasks have subordinate tasks, the task information retrieving unit 61 retrieves the task information 21 of the selected tasks (parent tasks) and the subordinate tasks (child tasks) from the task information DB 113.

When actually retrieving the task information 21 from the task information DB 113, the task information retrieving unit 61 reads the corresponding retrieval conditions from the task information retrieval condition area (or the task information retrieval condition storing unit 51) of the secondary storage unit 13, and narrows down the selected tasks based on the retrieval conditions. In other words, the task information retrieving unit 61 retrieves the task information 21 of tasks selected and also matching the retrieval conditions from the task information DB 113.

Thus, the workflow management server 100 of this embodiment is able to retrieve the task information 21 of selected tasks (parent tasks) and their subordinate tasks (child tasks) together, and to include them in a progress report. Also, the workflow management server 100 is able to narrow down selected tasks (and their subordinate tasks) to be included in a progress report based on task information retrieval conditions specified by the user.

The progress report generating unit 62 generates a progress report as an electronic document. The progress report generating unit 62 reads the corresponding circulation route ID from the circulation route information area (or the circulation route information storing unit 52) of the secondary storage unit 13 and generates a progress report based on the circulation route information 23 corresponding to the circulation route ID and the task information 21 retrieved by the task information retrieving unit 61.

More specifically, the progress report generating unit 62 generates a progress report through the steps described below.

(Step A) Retrieving Document Format

The progress report generating unit 62 searches the document format DB 112 based on the circulation route ID read from the circulation route information area (or the circulation route information storing unit 52) of the secondary storage unit 13 and thereby identifies and retrieves definition data of the corresponding document format.

(Step B) Generating Progress Report

The progress report generating unit 62 embeds the task information 21 retrieved by the task information retrieving unit 61 in the definition data of the document format retrieved in step A and thereby generates a progress report.

Details of steps A and B are described below.

In step A, the progress report generating unit 62 searches the document format DB 112 for document format information based on a circulation route ID.

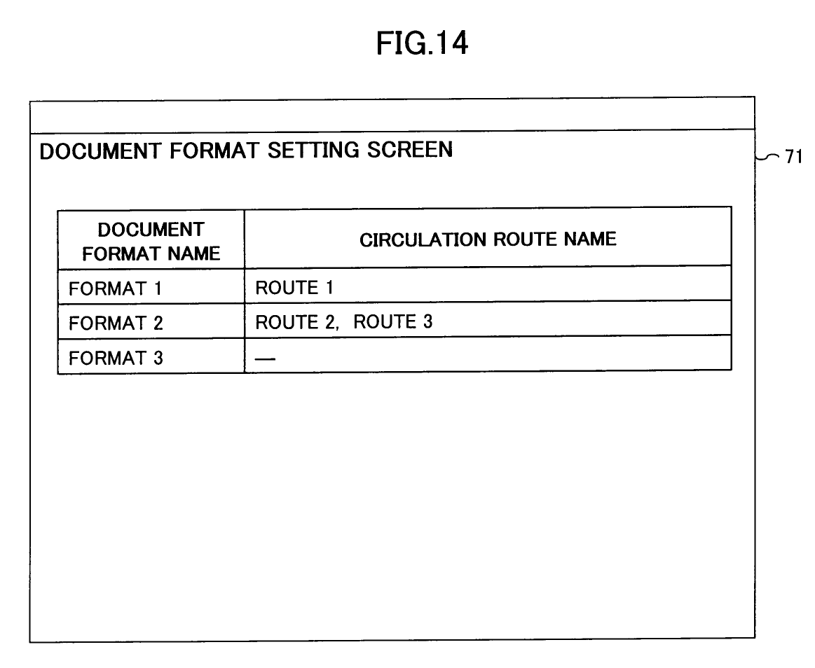

FIG. 14 is a drawing illustrating an exemplary document format setting screen for specifying document formats for circulation routes.

On the document format setting screen shown in FIG. 14, document format names and circulation route names are correlated.

The document format setting screen (GUI 71) enables the manager to specify a document format for each circulation route. The specified information is stored in the document format DB 112 as document format information. For example, as shown in FIG. 14, the manager enters document format names, such as “format 1”, “format 2”, and “format 3” corresponding to daily, weekly, and monthly reports, in “Document Format Name” text boxes on the GUI 71. Also, the manager determines one or more circulation routes for each type of document format, and enters circulation route names of the determined circulation routes, such as “route 1”, “route 2”, and “route 3”, in the corresponding “Circulation Route Name” text boxes.

According to the exemplary settings shown in FIG. 14, a progress report is generated based on “format 1” when “route 1” is selected, and a progress report is generated based on “format 2” when “route 2” or “route 3” is selected.

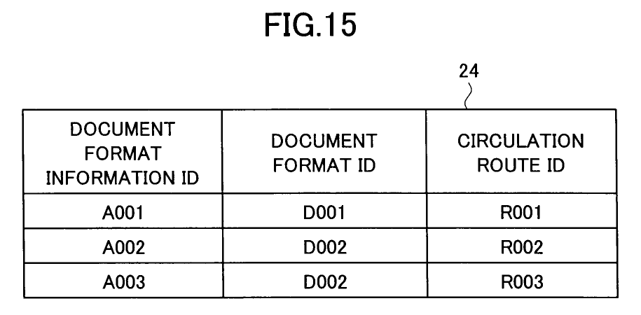

FIG. 15 is a table showing an exemplary structure of document format information in the document format DB 112.

The information specified on the document format setting screen shown in FIG. 14 is stored in the document format DB 112 as document format information 24 as shown in FIG. 15.

The document format information 24 includes a document format information ID identifying the document format information 24, a document format ID identifying a document format, and a circulation route ID identifying circulation route information.

In step A, the progress report generating unit 62 searches the document format DB 112 based on a circulation route ID read from the circulation route information area (or the circulation route information storing unit 52) of the secondary storage unit 13.

As the result of the search, the progress report generating unit 62 finds the document format information 24 corresponding to the circulation route ID, and obtains a document format ID from the obtained document format information 24.

For example, when the circulation route ID is “R002”, the progress report generating unit 62 searches the document format DB 112 (FIG. 15) using the circulation route ID “R002” as a search key, thereby finds the document format information 24 (document format information ID “A002”) with the circulation route ID “R002”, obtains a document format ID “D002” from the found document format information 24, and retrieves definition data of the document format corresponding to the document format ID “D002”.

In step B, the progress report generating unit 62 embeds the task information 21 retrieved by the task information retrieving unit 61 in the definition data retrieved in step A, and thereby generates a progress report.

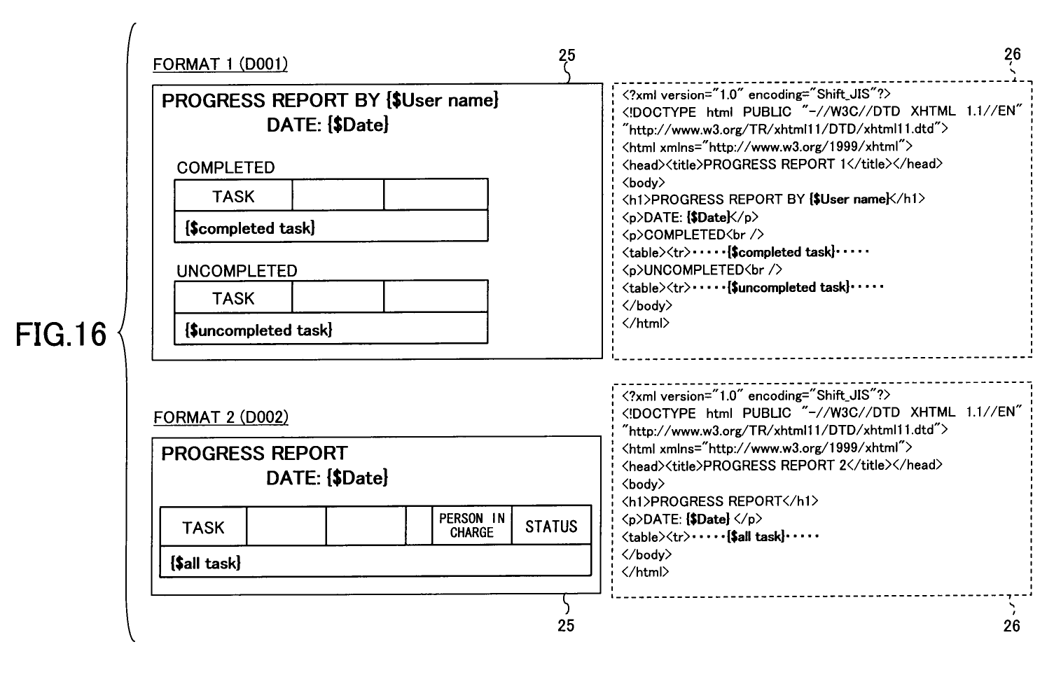

FIG. 16 is a drawing showing exemplary document formats 25 and their definition data 26.

As shown in FIG. 16, the definition data 26 of each of the document formats 25 are assigned a document format ID that corresponds to one of the document format IDs in the document format information 24 stored in the document format DB 112.

The definition data 26 define the corresponding document format 25 according to which progress report is generated, and are stored in a non-volatile storage device such as the secondary storage unit 13 in association with a document format ID.

The definition data 26 are, for example, text data written in an extensible markup language, such as the extensible hypertext markup language (XHTML), which defines formats of text using markup tags.

In the definition data 26 shown in the upper right of FIG. 16, formats of elements (e.g., headings, subheadings, text, tables, etc.) in the document format 25 shown in the upper left of FIG. 16 are defined by XHTML tags.

The progress report generating unit 62 retrieves the definition data 26 from, for example, the secondary storage unit 13 based on a document format ID as described above in step A, and loads the definition data 26 into the RAM of the main memory 12. Below, step B is described further in more detail.

The progress report generating unit 62 parses the definition data 26 loaded into the RAM of the main memory 12. For example, the progress report generating unit 62 parses the definition data 26 using a parser corresponding to the language in which the definition data 26 are written.

While parsing the definition data 26, the progress report generating unit 62 replaces symbols “{$xxx}” in the definition data 26 with the corresponding information items in the task information 21 and other information.

Take, for example, the definition data 26 shown in the upper right of FIG. 16. The progress report generating unit 62 parses the definition data 26 and replaces “{$user name}” with the name (character string) of the corresponding user and “{$Date}” with the date (character string) on which the progress report is being sent. Also, the progress report generating unit 62 replaces “{$completed task}” with the name (character string) of a completed task and “{$uncompleted task}” with the name (character string) of an uncompleted task (that is underway or not started yet).

Thus, the progress report generating unit 62 generates a progress report from the task information 21 retrieved by the task information retrieving unit 61 by identifying symbols “{$xxx}” in the definition data 26 and replacing them with the corresponding character strings or numbers (indicated by “xxx” in each symbol).

With the mechanism described above, the workflow management server 100 of this embodiment is able to generate a progress report as an electronic document according to a specified document format.

Referring back to FIG. 6, the progress report sending unit 63 sends the progress report generated by the progress report generating unit 62 to the manager terminals 300 according to a circulation route defined by the circulation route information 23 corresponding to a circulation route ID.

More specifically, the progress report sending unit 63 searches the circulation route information DB 111 based on a circulation route ID read from the circulation route information area (or the circulation route information storing unit 52) of the secondary storage unit 13.

The progress report sending unit 63 thereby finds the circulation route information 23 corresponding to the circulation route ID and obtains names of managers who review the progress report from the found circulation route information 23.

Then, the progress report sending unit 63 searches the user information DB 114 using the manager names as search keys, and obtains email addresses of the managers from the user information 22 found by the search.

For example, when the circulation route ID is “R002”, the progress report sending unit 63 searches the circulation route information DB 111 (FIG. 13) using the circulation route ID “R002” as a search key, finds the circulation route information 23 with the circulation route ID “R002”, and obtains manager names “Yamauchi” and “Maeta” from the circulation route information 23.

Then, the progress report sending unit 63 searches the user information DB 114 (FIG. 5) using the manager names “Yamauchi” and “Maeta”, finds the user information 22 pertaining to them (user IDs U031 and U032), and obtains their email addresses “yamauchi@abc.com” and “maeta@abc.com” from the user information 22.

The progress report sending unit 63 sends the progress report generated by the progress report generating unit 62 to the obtained email addresses of the managers, i.e., to the manager terminals 300.

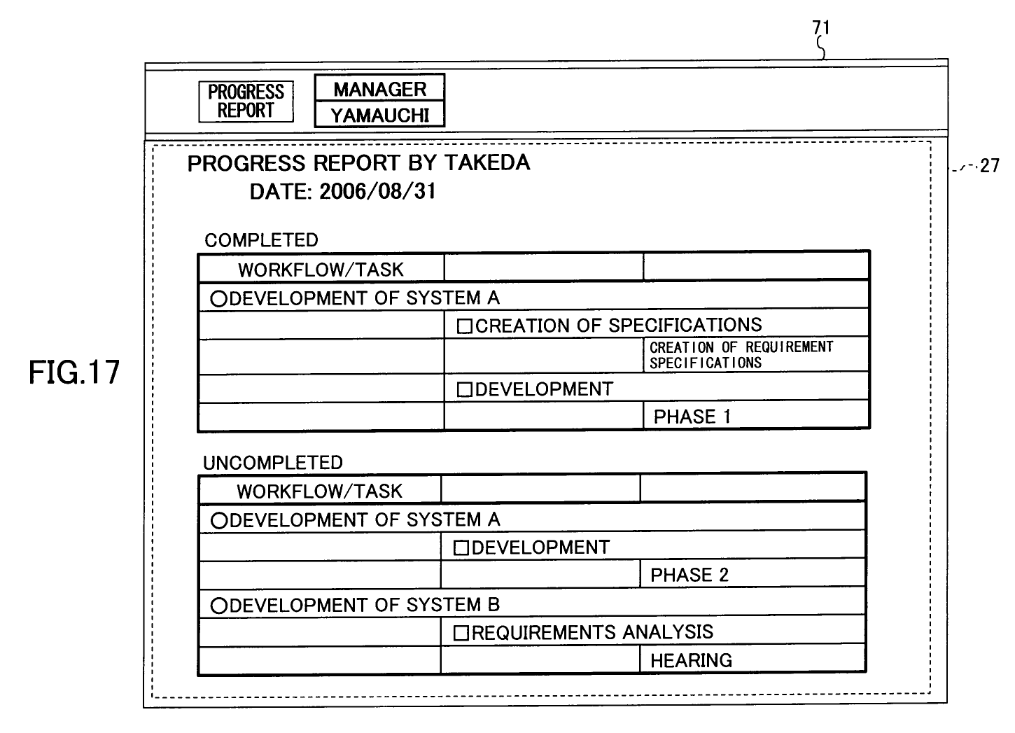

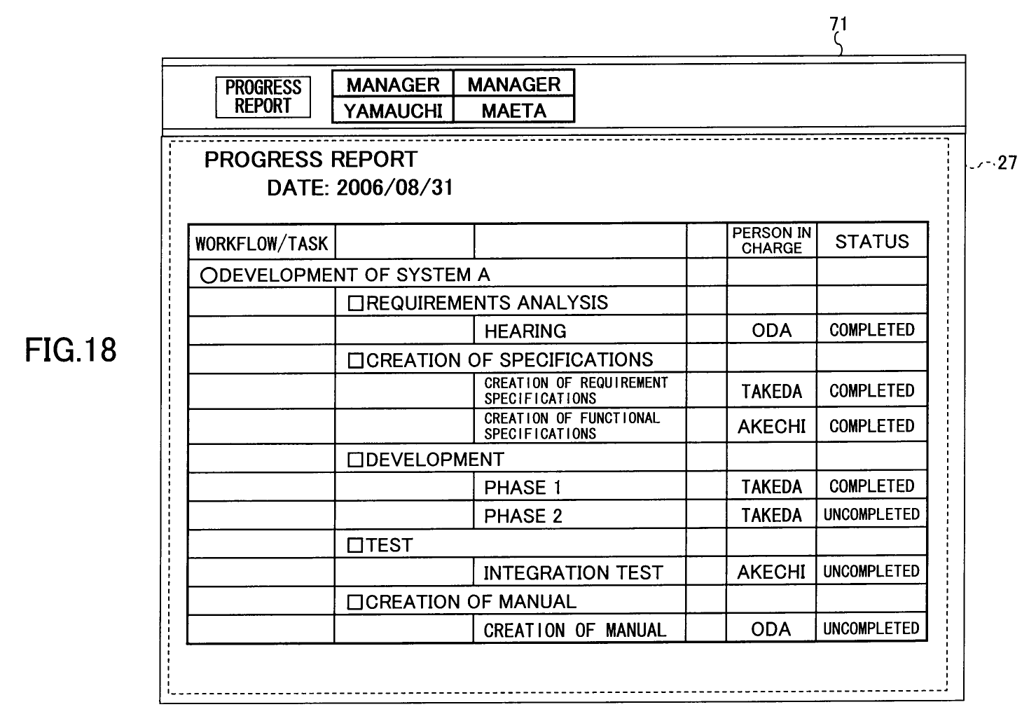

FIG. 17 is a drawing illustrating an exemplary progress report screen (circulation route 1). FIG. 18 is a drawing illustrating another exemplary progress report screen (circulation route 2 or 3).

As shown in FIGS. 17 and 18, each manager reviews a progress report 27 sent according to the specified circulation route by the progress report sending unit 63 on the progress report screen (GUI 71) displayed on the manager terminal 300.

Thus, the workflow management server 100 of this embodiment is able to send progress reports to the manager terminals 300.

In the workflow management system 1 of this embodiment, a task progress management process is performed through steps described below by the above described functional units of the workflow management server 100 and the user terminal 200.

(Step 1) Sending Progress Report Setting Information

The task information retrieval condition sending unit 41, the circulation route information sending unit 42, and the report timing information sending unit 43 of the user terminal 200, respectively, send task information retrieval conditions set by the task information retrieval condition setting unit 31, a circulation route ID (or the circulation route information 23 itself) set by the circulation route information setting unit 32, and report timing information set by the report timing information setting unit 33, to the workflow management server 100 as progress report setting information.

(Step 2) Retrieving Task Information

The workflow management server 100 stores the task information retrieval conditions, the circulation route ID (or the circulation route information itself), and the report timing information sent from the user terminal 200, respectively, in the task information retrieval condition area, the circulation route information area, and the report timing information area (or the storing units 51, 52, and 53) of the secondary storage unit 13.

The task information retrieving unit 61 retrieves the task information 21 of tasks to be included in the progress report 27 from the task information DB 113.

More specifically, the task information retrieving unit 61 reads the retrieval conditions from the task information retrieval condition area (or the task information retrieval condition storing unit 51) in the secondary storage unit 13, and narrows down the tasks selected by the user based on the retrieval conditions. Then, the task information retrieving unit 61 retrieves the task information 21 of the tasks selected and also matching the retrieval conditions from the task information DB 113.

(Step 3) Generating Progress Report

The progress report generating unit 62 reads the circulation route ID (or the circulation route information 23 itself) from the circulation route information area (or the circulation route information storing unit 52) of the secondary storage unit 13 and generates the progress report 27 through steps 3-1 and 3-2 described below based on the circulation route information 23 corresponding to the circulation route ID and the task information 21 retrieved by the task information retrieving unit 62.

(Step 3-1) Retrieving Document Format

The progress report generating unit 62 searches the document format DB 112 using the circulation route ID as a search key, thereby finds the corresponding document format information 24, and obtains a document format ID from the found document format information 24.

(Step 3-2) Embedding Task Information

The progress report generating unit 62 retrieves the definition data 26 defining the document format 25 corresponding to the obtained document format ID from, for example, the secondary storage unit 13, and loads the definition data 26 into the RAM of the main memory 12.

Then, the progress report generating unit 62 parses the definition data 26 loaded into the RAM of the main memory 12.

The progress report generating unit 62 identifies symbols “{$xxx}” in the definition data 26, replaces them with the corresponding information items (character strings or numbers) in the retrieved task information 21 and other information (indicated by “xxx” in each symbol), and thereby generates the progress report 27.

(Step 4) Sending Progress Report

The progress report sending unit 63 sends the generated progress report 27 to the manager terminals 300 according to the circulation route defined by the circulation route information 23 corresponding to the circulation route ID.

The workflow management server 100 repeats steps 2 through 4 at the interval (e.g., the number of days) specified by the report timing information stored in the report timing information area (or the report timing information storing unit 53) of the secondary storage unit 13.

Thus, through steps 1 through 4 described above, the workflow management system 1 of this embodiment performs a task progress management process of automatically generating progress reports on tasks as electronic documents and sending the generated progress reports to specified manager terminals 300.

It must be noted, however, that the method of setting, sending, and storing progress report setting information is not limited to that described in steps 1 and 2. Any method may be used as long as the progress report setting information is stored in a non-volatile storage device, e.g., the secondary storage unit 13, of the workflow management server 100 for use in a task progress management process.

### <Task Progress Management Process>

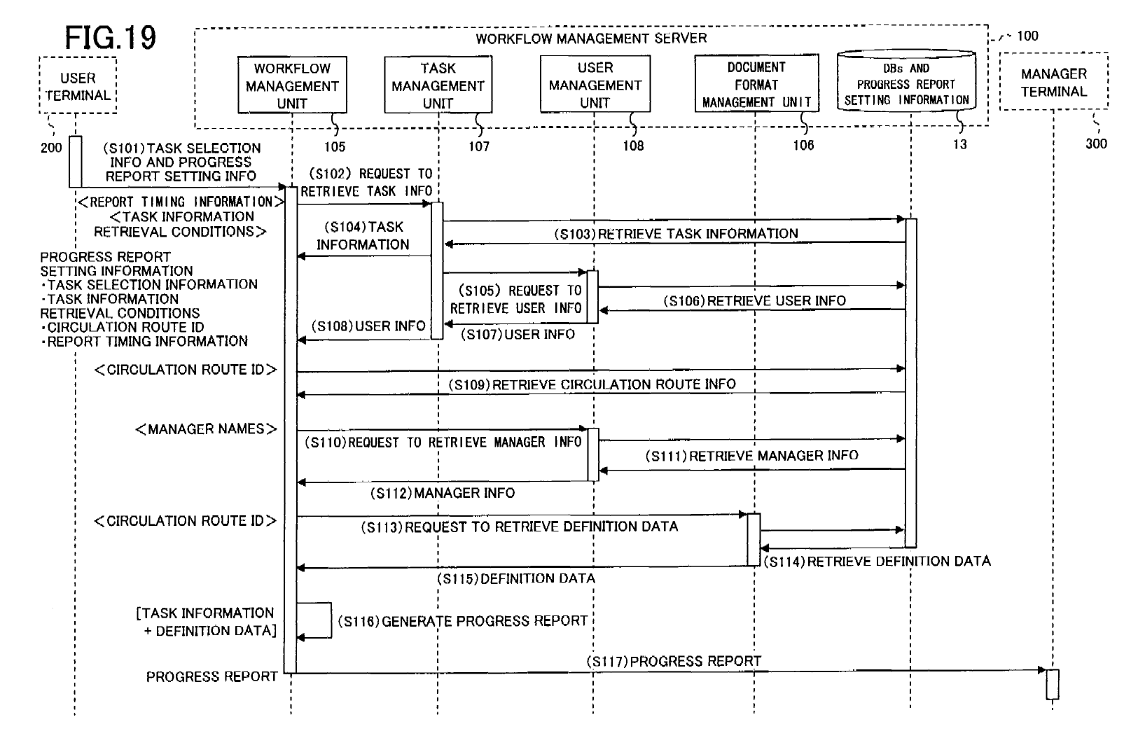

An exemplary task progress management process in the workflow management system 1 is described below with reference to FIG. 19.

FIG. 19 is a sequence chart showing an exemplary task progress management process in the workflow management system 1.

The workflow management server 100 and the user terminal 200 of the workflow management system 1 execute programs loaded into their respective main memories 12 with their respective control units 11 and thereby perform a task progress management process including steps S101 through S116 described below.

Prior to step S101, the task information retrieval condition setting unit 31, the circulation route information setting unit 32, and the report timing information setting unit 33 of the user terminal 200, respectively, set task information retrieval conditions, a circulation route ID (or the circulation route information 23 itself), and report timing information. Also, the user selects tasks to be included in the progress report 27 on the GUI 71.

Then, the task information retrieval condition sending unit 41, the circulation route information sending unit 42, and the report timing information sending unit 43 of the user terminal 200, respectively, send the task information retrieval conditions, the circulation route ID (or the circulation route information 23 itself), and the report timing information to the workflow management server 100 as progress report setting information (S101). A list of the tasks selected by the user (task selection information) is also sent to the workflow management server 100 as a part of or separately from the progress report setting information.

The workflow management server 100 stores the task information retrieval conditions, the circulation route ID (or the circulation route information 23 itself), and the report timing information sent from the user terminal 200i respectively, in the task information retrieval condition area, the circulation route information area, and the report timing information area (or the storing units 51, 52, and 53) of the secondary storage unit 13.

The workflow management server 100 repeatedly performs steps S102 through S116 at the interval (e.g., the number of days) specified by the report timing information stored in the report timing information area (or the report timing information storing unit 53).

The workflow management unit 105 requests the task management unit 107 to retrieve the task information 21 of tasks to be included in the progress report 27 based on the task selection information and the retrieval conditions in the task information retrieval condition area (or the task information retrieval condition storing unit 51) of the secondary storage unit 13 (S102).

When requested, the task management unit 107 retrieves the corresponding task information 21 from the task information DB 113 (S103) and returns the retrieved task information 21 to the workflow management unit 105 (S104).

Also, the task management unit 107 requests the user management unit 108 to retrieve the user information 22 of users from the user information DB 114 based on user IDs in the retrieved task information 21 (S105).

According to the request, the user management unit 108 retrieves the corresponding user information 22 (e.g., names and email addresses of users) from the user information DB 114 (S106), and returns the retrieved user information 22 to the task management unit 107 (S107).

The task management unit 107 sends the user information 22 to the workflow management unit 105 (S108) Then, the workflow management unit 105 retrieves the circulation route information 23 (e.g., names of managers to whom the progress report 27 is to be sent) from the circulation route information DB 111 based on the circulation route ID read from the circulation route information area (or the circulation route information storing unit 52) of the secondary storage unit 13 (S109).

Next, the workflow management unit 105 requests the user management unit 108 to retrieve the user information 22 of managers (manager information) from the user information DB 114 based on the manager names in the retrieved circulation route information 23 (S110).

According to the request, the user management unit 108 retrieves the corresponding user information 22 (e.g., names and email addresses of managers) from the user information DB 114 (S111), and returns the retrieved user information 22 (manager information) to the workflow management unit 105 (S112).

The workflow management unit 105 requests the document format management unit 106 to retrieve the definition data 26 defining the document format 25 assigned to the circulation route corresponding to the circulation route ID read from the circulation route information area (or the circulation route information storing unit 52) of the secondary storage unit 13 (S113).

According to the request, the document format management unit 106 searches the document format DB 112 using the circulation route ID as a search key, thereby finds the document format information 24 with the circulation route ID, and obtains a document format ID from the document format information 24.

Then, the document format management unit 106 retrieves the definition data 26 corresponding to the document format ID from, for example, the secondary storage unit 13 (S114).

The document format management unit 106 returns the retrieved definition data 26 to the workflow management unit 105 (S115).

The workflow management unit 105 parses the definition data 26, thereby identifies symbols “{$xxx}” in the definition data 26, and replaces the symbols “{$xxx}” with the corresponding information items in the retrieved task information 21 and other information to generate the progress report 27 (S116).

The workflow management unit 105 sends the generated progress report 27 to the manager terminals 300 (e.g., to email addresses of managers) according to the circulation route defined by the circulation route information 23 (S117).

Thus, by steps S101 through S116 described above, the workflow management system 1 repeatedly performs a task progress management process of retrieving the task information 21 of tasks to be included in the progress report 27, generating the progress report 27 based on the retrieved task information 21 and specified circulation route information, and sending the generated progress report 27 to managers according to the circulation route defined by the circulation route information, at the interval specified by report timing information.

With the configurations, mechanisms, or methods described above, the workflow management system 1 according to embodiments of the present invention is able to automatically generate progress reports of tasks as electronic documents and to send the generated progress reports to managers.

As described above, in the workflow management system 1, a task progress management process is performed by functional units of the workflow management server 100 and the user terminal 200. The functional units can be implemented by executing program code written in a programming language by a computer with a platform supporting the programming language. In other words, a task progress management process or a method of managing progress of tasks in the workflow management system 1 according to embodiments of the present invention may be implemented as program code stored in a storage medium.

The workflow management server 100 provides a mechanism for automatically generating progress reports of tasks as electronic documents and sending the generated progress reports. The task information retrieval condition setting unit 31, the circulation route information setting unit 32, the report timing information setting unit 33, the task information retrieval condition sending unit 41, the circulation route information sending unit 42, and the report timing information sending unit 43 of the user terminal 200 provide an exemplary mechanism for setting progress report setting information including task information retrieval conditions, a circulation route ID (or the circulation route information 23 itself), and report timing information and for sending the progress report setting information to the workflow management server 100. Any other mechanism or method may be used for this purpose as long as the progress report setting information is stored in a non-volatile storage device, e.g., the secondary storage unit 13, of the workflow management server 100 for use in a task progress management process. According to an embodiment of the present invention, the workflow management server 100 is able to retrieve the task information 21 of selected tasks (parent tasks) and their subordinate tasks (child tasks) together, and to include them in a progress report. This configuration makes it possible for the user to correctly report progress of one's tasks even when child tasks under a parent task are added, modified, or removed.

According to an embodiment of the present invention, the workflow management server 100 is able to narrow down tasks to be included in a progress report based on task information retrieval conditions specified by the user. This configuration makes it possible for the user to limit the amount of information in a progress report.

According to an embodiment of the present invention, the workflow management server 100 is able to generate and send progress reports to managers at the interval specified by the user. This configuration makes it possible to flexibly set a timing for sending a progress report according to the type (e.g., a daily report, a weekly report, or a monthly report) of the progress report.

Embodiments of the present invention provide a workflow management system, a workflow management server, a workflow management method, and a storage medium containing program code that make it possible to automatically retrieve task information of tasks to be included in a progress report, generate the progress report based on the retrieved task information and specified circulation route information, and send the generated progress report to managers according to a circulation route defined by the circulation route information.

The present invention is not limited to the specifically disclosed embodiments, and variations and modifications may be made without departing from the scope of the present invention.

The present application is based on Japanese Priority Application No. 2007-057884, filed on Mar. 7, 2007, the entire contents of which are hereby incorporated herein by reference.

What is claimed is:

1. A workflow management server for managing task information, which is stored in a database, of tasks constituting a workflow, which workflow management server is connected via a network to one or more terminals for reviewing a progress report on progress of the tasks, the workflow management server comprising:
a circulation route information storing unit configured to store circulation route information defining a circulation route of the progress report;
a task information retrieving unit configured to retrieve the task information of the tasks to be included in the progress report from the database according to a user request;
a progress report generating unit configured to generate the progress report based on the task information retrieved by the task information retrieving unit and the circulation route information read from the circulation route information storing unit; and
a progress report sending unit configured to send the progress report generated by the progress report generating unit to the terminals according to the circulation route defined by the circulation route information.

2. The workflow management server as claimed in claim 1, wherein if the tasks to be included in the progress report have subordinate tasks, the task information retrieving unit retrieves the task information of the subordinate tasks together with that of the tasks from the database.

3. The workflow management server as claimed in claim 1, further comprising:
a task information retrieval condition storing unit configured to store a task information retrieval condition;
wherein the task information retrieving unit is configured to retrieve the task information of the tasks from the database based on the task information retrieval condition read from the task information retrieval condition storing unit.

4. The workflow management server as claimed in claim 1, further comprising:
a report timing information storing unit configured to store report timing information specifying an interval; wherein
the task information retrieving unit is configured to retrieve the task information from the database at the interval specified by the report timing information read from the report timing information storing unit;
the progress report generating unit is configured to generate the progress report based on the retrieved task information and the circulation route information at the interval; and
the progress report sending unit is configured to send the generated progress report to the terminals according to the circulation route at the interval.

5. A method of managing progress of tasks constituting a workflow in a workflow management system that includes a workflow management server for managing task information, which is stored in a database, of the tasks and that includes one or more terminals connected via a network to the workflow management server and used to review a progress report on the progress of the tasks, the method comprising the steps of:
storing circulation route information defining a circulation route of the progress report in a circulation route information storing unit of the workflow management server;
retrieving the task information of the tasks to be included in the progress report from the database according to a user request;
generating the progress report based on the retrieved task information and the circulation route information read from the circulation route information storing unit; and
sending the generated progress report to the terminals according to the circulation route defined by the circulation route information.

6. A storage medium having program code embodied therein for causing a computer to function as a task information retrieving unit, a progress report generating unit, and a progress report sending unit of a workflow management server for managing task information, which is stored in a database, of tasks constituting a workflow, the workflow management server being connected via a network to one or more terminals for reviewing a progress report on progress of the tasks, wherein
the computer includes a circulation route information storing unit configured to store circulation route information defining a circulation route of the progress report;
the task information retrieving unit is configured to retrieve the task information of the tasks to be included in the progress report from the database according to a user request;
the progress report generating unit is configured to generate the progress report based on the task information retrieved by the task information retrieving unit and the circulation route information read from the circulation route information storing unit; and
the progress report sending unit is configured to send the progress report generated by the progress report generating unit to the terminals according to the circulation route defined by the circulation route information.
